(19) United States
(12) Patent Application Publication
(10) Pub. No.: US 2009/0221942 A1
(43) Pub. Date: Sep. 3, 2009

(54) Massaging brassiere structure

(76) Inventor: Jia-Lianq Shian, Pyng-Jenn City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,183

(22) Filed: Mar. 3, 2008

(51) Int. Cl. A61H 1/00; A41C 3/00

(52) U.S. Cl. 601/46; 601/70; 450/1

(57) ABSTRACT

The present invention discloses a massaging brassiere structure that installs an electronic vibrator in brassiere cups of the brassiere, and the electronic vibrator is controlled by an electronic circuit for vibrations and driving an elastic filling layer of the brassiere cup to vibrate, so that the vibrating frequency produced by the electronic vibrator is transmitted evenly to a wearer's breasts by the elastic force of the elastic filling layer of the brassiere cup for massaging the wearer's breasts.

### BACKGROUND OF THE INVENTION

1. Field of the Invention

The present invention relates to a massaging brassiere structure, and more particularly to a novel massaging brassiere structure being connected to a brassiere in a simple, easy, convenient and direct way and providing a massaging effect to wearers' breasts.

2. Description of the Related Art

As women wear brassieres as underwear, but people's concept keep changing, innovating and advancing, the use of woman's brasserie gradually changes from simply wearing a underwear to combining the effect of showing the beautiful look of a woman's body and wearing comfort. Regardless of the material or the stylish appearance of the woman's brasserie, the brassiere has to achieve the effect of supporting and fixing the breasts in proper positions, and thus the brassiere needs to combine with an elastic binding strip. Although the elastic binding strip can bind up the breasts to a certain level, it also creates a certain level of binding force to the breasts at the same time. Therefore, finding a way of timely and appropriately ease off the pressure on the breasts while women are wearing brassieres becomes an issue for manufacturers to solve.

### SUMMARY OF THE INVENTION

The primary objective of the present invention is to provide a massaging brassiere structure, wherein electronic vibrator is installed and hidden into an elastic filling layer of a brassiere cup for providing a vibrating frequency at an appropriate time, and the elastic filling layer is driven to produce even vibrating waves which are transmitted directly to the breasts in the brassiere cups, so as to provide a massaging effect and ease off the binding pressure of the breasts.

### BRIEF DESCRIPTION OF THE DRAWINGS

FIG. 1 is a front view of the present invention; and

FIG. 2 is a lateral cross-sectional view of the present invention.

### DETAILED DESCRIPTION OF THE PREFERRED EMBODIMENTS

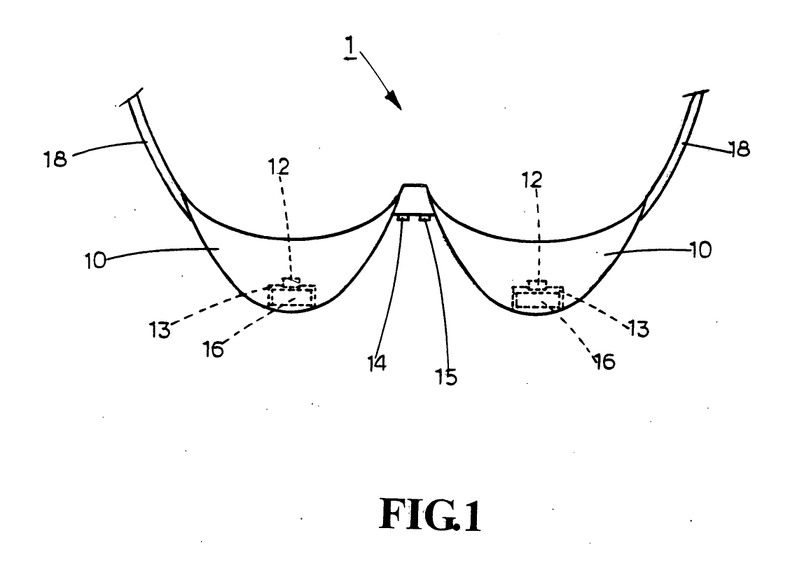

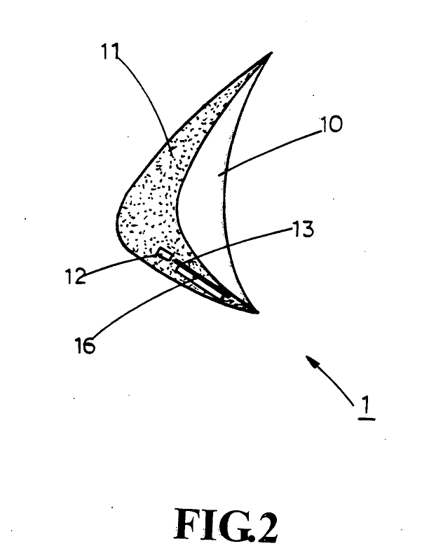

Referring to FIGS. 1 and 2 for the structure of a massaging brassiere structure of the present invention, an electronic vibrator 12 is installed and hidden into an elastic filling layer 11 (such as silicon latex and sponge) of two brassiere cups 10 of a brassiere 1, and the electronic vibrator 12 is controlled by an electronic circuit 13, and the electronic circuit 13 comprises a power switch 14, a charging connector 15 and a battery 16, wherein a battery 16 is a small-size and high-capacity battery (such as a lithium battery) installed at any appropriate position of the brassiere 1 (this invention adopts the shape of the lower edge of the brassiere cup 10 as a basis to hide the battery in the elastic filling layer 11 according to this embodiment, so as to improve the beautiful look and comfort of wearing the brassiere). The electronic circuit 13 is made of a small circuit board installed at any appropriate position of the brassiere 1 (the present invention installs an electronic wire 13 inside an elastic filling layer 11 of the brassiere cup 10 according to a preferred embodiment). Further, the power switch 14 and the charging connector 15 can be installed at any appropriate positions of the brassiere 1 (the invention installs the power switch 14 and charging connector 15 equally at the connecting position of both left and right brassiere cups 10 to facilitate its operation). In the aforementioned structure of the invention, the charging connector 15 can be used for charging the battery 16 anytime, and the power supply of the battery 16 and the control of the power switch 14 and the electronic circuit 13 are used for controlling and turning on or off the vibrations of the electronic vibrator 12. In other words, the brassiere 1 of the invention is worn on a wearer's body and the power switch 14 is turned on, and the electronic vibrator 12 hidden in the elastic filling layer 11 of the brassiere cup 10 will automatically produce vibrations, and the elastic filling layer 11 has the characteristics of elasticity and softness, and the electronic vibrator 12 produces vibrations, so as to produce even vibrating waves to the whole elastic filling layer 11, and further the brassiere cups 10 can support and cover the wearer's breasts and the even vibrating waves of the elastic filling layer 11 can directly provide comfortable vibrating massages, and the elastic binding strip 18 of the brassiere 1 applies a binding pressure to achieve the effect of fully easing off the pressure.

In summation of the description above, users can turn off the vibration of the electronic vibrator 12 anytime by controlling the power switch 14 according to the actual need, so as to stop the vibrating massage to the wearer's breasts.

What is claimed is:

1. A massaging brassiere structure, comprising a brassiere cup, an elastic filling layer, an electronic vibrator, a battery, an electronic circuit and a power switch, wherein said electronic vibrator is installed in said brassiere cup, and said electronic vibrator produces a vibration by the power supply of said power battery and the control of said electronic circuit and said power switch, such that said brassiere cup is driven to produce vibrating waves to a wearer's breasts.

2. The massaging brassiere structure of claim 1, wherein said electronic vibrator is hidden into an elastic filling layer of said brassiere cup.

3. The massaging brassiere structure of claim 1, wherein said electronic circuit is made of a small circuit board and hidden together with said battery and said power switch into an elastic filling layer of said brassiere cup.

4. The massaging brassiere structure of claim 1, wherein said electronic circuit installs a charging connector for said battery to charge electric power.

5. The massaging brassiere structure of claims 1, wherein said electronic circuit, said battery, said power switch and said charging connector are installed at any appropriate positions of said brassiere.
